(19) United States
(12) Patent Application Publication
(10) Pub. No.: US 2002/0138709 A1
(43) Pub. Date: Sep. 26, 2002

(54) Peripheral component interconnect bus memory address decoding

(76) Inventors: Alan Edward Ball, West Sussex (GB); David John White, West Sussex (GB)

Correspondence Address: NIXON & VANDERHYE P.C., 8th Floor, 1100 North Glebe Road, Arlington, VA, 22201, US

(21) Appl. No.: 10/101,527

(22) Filed: Mar. 20, 2002

(30) Foreign Application Priority Data
Mar. 20, 2001 (GB) 0107037.4

(51) Int. Cl. G06F 12/00

(52) U.S. Cl. 711/211; 710/107

(57) ABSTRACT

A peripheral component interconnect (PCI) bus memory addressing system comprising a memory address decoder and disconnection means connected to a PCI bus, the disconnection means being arranged to disconnect one or more signals of the PCI bus from a first PCI device, wherein the memory address decoder is arranged to selectively activate the disconnection means such that an address which falls within an address range identified in a base address register of the first PCI device and a base address register of a second PCI device will be received by the second PCI device but not by the first PCI device.

The present invention relates to Peripheral Component Interconnect (PCI) bus memory address decoding.

A PCI bus is commonly used to connect a Central Processing Unit (CPU) to peripheral components, for example a graphics adapter or audio peripheral. The PCI bus architecture was developed by Intel to provide efficient transfer of data to and between peripheral components, and was adopted as a standard architecture. The PCI standard is periodically revised, for example increasing the permitted speed of operation.

The PCI bus architecture provides three separately addressable spaces. These are configuration space, input/output space (IO space) and memory space. Each PCI device requires regions of memory and/or IO space to be allocated exclusively to it in order to allow it to perform its intended function. This allocation is the responsibility of system initialisation software running on a System Controller, often called the “host”.

Each PCI device occupies a fixed region of configuration space, and within this region implements a set of registers, called the configuration header of the device. The contents of certain of these registers are preprogrammed during device manufacture with various attributes of the device, for example the vendor and type of the device, and in particular the amount of memory and I/O space required by the device to perform its post initialisation function. The layout of the registers within the configuration header of each device is defined by the PCI specification, whilst the hardware platform interconnecting the host with the PCI devices provides a hardwired scheme to ensure that each configuration header is located at a different address in PCI configuration space. This allows the host to readily address any register in the configuration header of any device immediately after system power-on, for example during start-up, the host is able to determine what PCI devices are present by scanning all possible configuration space addresses.

The memory space and/or IO space which is required by a PCI device in order to allow it to perform its function is specified in Base Address Registers (BAR's) located in the configuration header. A PCI device may have up to 6 separate BAR's. The number of BAR's is dependent upon the number of separate areas of memory space and/or IO space that are required by the device. Each BAR defines the size and attributes of a requested region of memory or I/O space. During system initialisation, the host reads the contents of the BAR's, and determines where to locate the requested memory space and/or IO space, taking into account the requirements of other devices. The host then writes into each BAR the base address of the memory space and/or IO space allocated in response to the request from that BAR. The PCI device has no control or influence over the allocated base address. To simplify BAR implementation, the PCI specification requires that memory/IO space can only be requested in modulo-2 sizes i.e. 4 KB, 8 KB,16 KB.. etc, and that the allocated base address must be aligned to the requested size of space (e.g. if 2 MB is requested, then the allocated base address will lie on a 2 MB boundary).

Allocated resources cannot overlap between two different PCI devices (i.e. the resources used by all devices in the system must be mutually exclusive).

The number of PCI devices which can be connected to a PCI bus is limited by the PCI specification in order to guarantee the electrical performance of the bus. To overcome this limitation, a PCI-PCI bridge was developed. The PCI-PCI bridge is a hardware device (chip) which forms a logically transparent bridge between two electrically separate PCI bus “segments”. A large PCI system may comprise many segments, and in some cases more than one level of bridges (i.e. a bridge connects to a bus segment which itself has attached a further bridge to another bus segment etc).

A PCI system comprising many segments will support a large number of PCI devices, each of which may require IO space and/or memory space. The total amount of memory/IO space available is limited by the addressing range of the PCI bus itself In a large system containing many PCI devices which each require substantial amounts of memory/I0 space, the total amount of memory/IO space to be allocated may begin to approach the maximum available space

A further complication arises in that the PCI-PCI bridges themselves, although not requiring resources for their own use (since they perform no function other than interconnect), must provide “windows” to allow transactions to reach those PCI devices to which they bridge. This means that PCI-PCI bridges themselves must include BAR's for IO spaces and memory spaces. In the same way that the resources allocated to each PCI device cannot overlap, so each PCI-PCI bridge can only “window” a unique region of each address space.

The constraints of the PCI standard may give rise to a memory addressing problem when a PCI-PCI bridge is used. Each PCI-PCI bridge has only a single BAR to define the window that it will open in memory space. This means that a large amount of memory space is wasted when two PCI devices which require very different sizes of resource are both located behind a PCI-PCI bridge. For example, a first PCI device which requires 1 MB of memory space and a second PCI device which requires 64 MB of memory space may be located behind a PCI-PCI bridge. The PCI-PCI bridge has only a single BAR to define the window that it will open in memory space. Since the BAR in the PCI-PCI bridge can only request modulo-2 sizes of memory, it must request 128 MB to cover the required 65 MB. No other device can overlap this 128 MB window, and the unused 63 MB is effectively lost to the system unless other PCI devices can be located behind the bridge to use some of the memory space (in many cases this may not be possible due to lack of available slots or other system constraints). In a large system having several such arrangements of PCI-PCI bridges and PCI devices this loss of useable memory space may ultimately lead to the entire memory space being filled, thereby preventing the addition of any further PCI devices to the system.

It is an object of the present invention to overcome the above limitation.

According to a first aspect of the invention there is provided a peripheral component interconnect (PCI) bus memory addressing system comprising a memory address decoder and disconnection means connected to a PCI bus, the disconnection means being arranged to disconnect one or more signals of the PCI bus from a first PCI device, wherein the memory address decoder is arranged to selectively activate the disconnection means such that an address which falls within an address range identified in a base address register of the first PCI device and a base address register of a second PCI device will be received by the second PCI device but not by the first PCI device.

The invention allows overlapping addresses to be assigned to base address registers of the first and second PCI devices. This is particularly useful when the address ranges of the first and second PCI devices are very different in size and the devices are both located behind a PCI-PCI bridge which has only one base address register, because it avoids the PCI-PCI bridge having to allocate a memory address range that is considerably greater than the sum of the memory address ranges required by the first and second PCI devices.

Suitably, the disconnection means comprises a switch arranged to disconnect the PCI_FRAME* signal from the first PCI device.

Suitably, the switch is closed when no data transactions are taking place, the switch being opened when the memory address decoder decodes an address which falls within the address range identified both in the base address register of the first PCI device and the base address register of the second PCI device.

Suitably, the switch remains open during a transaction with the second PCI device, and is closed when that transaction ends.

Suitably, the switch is a zero delay switch, and the memory address decoder is arranged to decode an address and open the switch prior to a clock incrementation which immediately follows the address signal.

Suitably, the disconnection means comprises a switch arranged to disconnect the PCI_FRAME* signal, the PCI_AD[31..0] signal and other control signals from the first PCI device.

Suitably, the switch is open when no data transactions are taking place, the switch being closed when the memory address decoder decodes an address which falls within the address range identified in the base address register of the first PCI device and which does not fall within the base address register of the second PCI device.

Suitably, in addition to opening the switch, the memory address decoder transfers the address, PCI_FRAME* and other control signals to the first PCI device.

Suitably, the address, PCI_FRAME* and other control signals are transferred to the first PCI device after a clock incrementation which immediately follows the address Signal.

Suitably, the switch remains closed until the transaction with the first PCI device is complete, whereupon the switch is opened.

Suitably, the switch is a 39 bit switch.

Suitably, the switch is a zero-delay switch.

Suitably, the other control signals include at least one of PCI_IRDY*, PCI_PAR and PCI_CBE[3..0]*.

Suitably, the first and second PCI devices, the memory address decoding means, the switch and the PCI bus are all located behind a PCI-PCI bridge.

Suitably, the memory address decoder is programmable, and is programmed with allocated address ranges for the first and second PCI devices.

According to a second aspect of the invention there is provided a PCI bus memory addressing method comprising determining the memory space requirements of a first PCI device and a second PCI device connected to a PCI bus, restricting the memory space used by the first PCI device, and allocating the address range of the resulting spare memory space to the second PCI device, wherein the method further comprises connecting a memory address decoder and a disconnection means to the PCI bus, the memory address decoder being arranged to selectively activate the disconnection means such that an address which falls within an address range identified in a base address register of the first PCI device and a base address register of a second PCI device will be received by the second PCI device but not by the first PCI device.

The method may incorporate any of the above mentioned features of the first aspect of the invention.

A specific embodiment of the invention will now be described by way of example only, with reference to the accompanying figures in which:

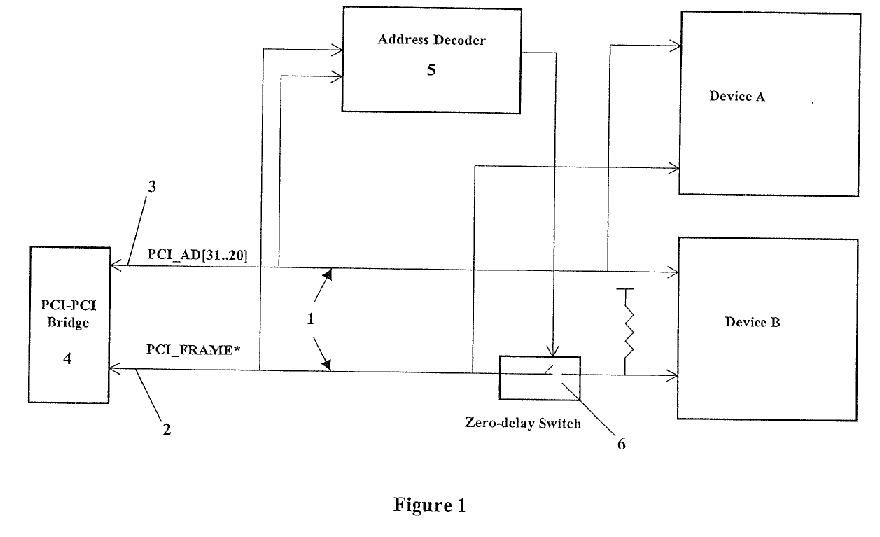

FIG. 1 is a schematic illustration of a first embodiment of the invention;

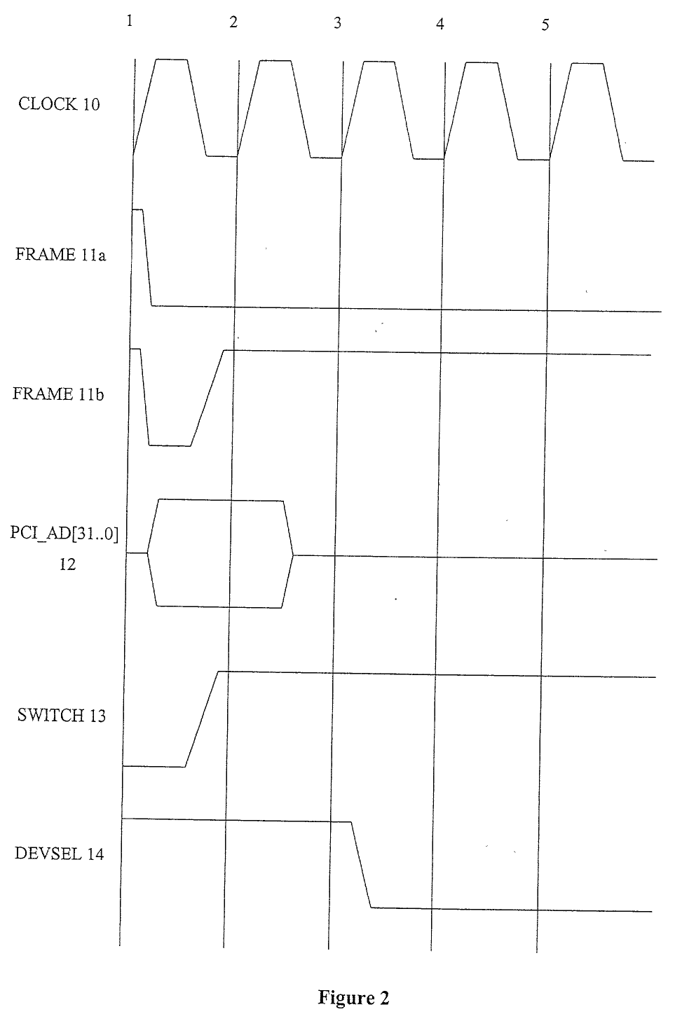

FIG. 2 is graphical illustration of the operation of the first embodiment of the invention;

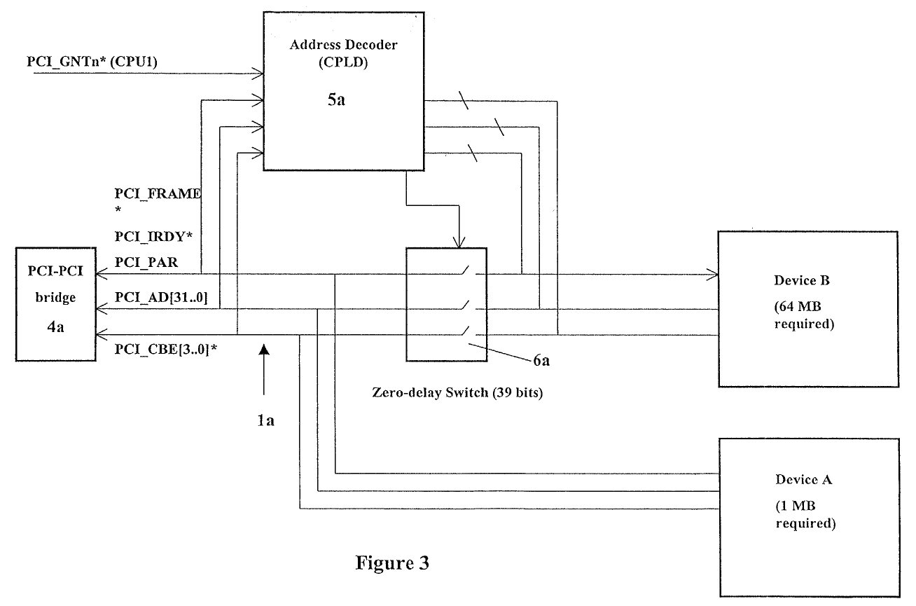

FIG. 3 is a schematic illustration of a second embodiment of the invention; and

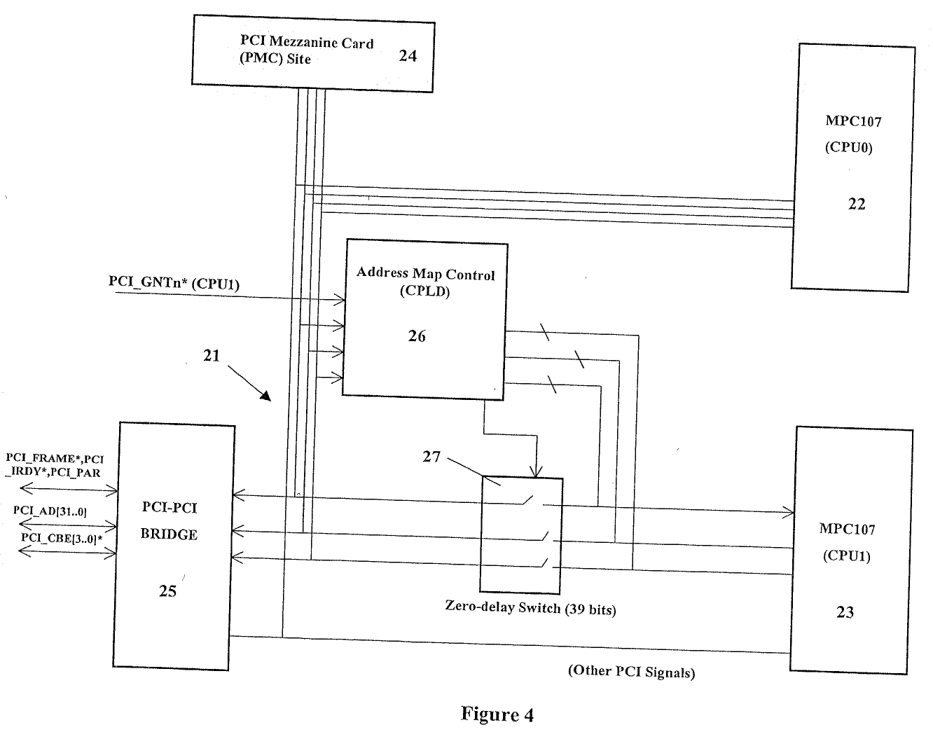

FIG. 4 is a schematic illustration of an implementation of the second embodiment of the invention.

Referring to FIG. 1 two devices, device A and device B, are connected to a PCI bus generally indicated as 1. The PCI-bus is not shown in full, but instead only specific components of the PCI bus are shown: PCI_FRAME* 2 and PCI_AD[31..0] 3. PCI_FRAME* is a signal which indicates that a transaction is about to take place or is already taking place. PCI_AD[31..0] is a signal which indicates the address of the intended recipient of a transaction during a first cycle of that transaction, and carries data during subsequent cycles of the transaction

The PCI bus 1 is located behind a PCI-PCI bridge 4.

Device A requires 1 MB of memory space and device B requires 64 MB of memory space. These requirements are indicated in the base address registers (BAR's) of the devices. The PCI-PCI bridge has only a single BAR to define the window that it will open in memory space.

Typically, it will be determined that device B does not require 64 MB of memory, and will in fact function correctly with only 63 MB of memory. This is because device B is forced to claim (via its BAR's) more memory space than it actually needs as a consequence of the modulo-2 memory space restriction referred to above. Device B may be a CPU. Where this is the case, restricting the amount of allocated memory space has the effect of making part of the CPU memory invisible from PCI. If the software running on the CPU doesn't use this invisible portion (because it implements more memory than is required by the software) then restricting the amount of allocated memory has no impact. If the software running on the CPU does use the invisible portion, then the effect of the memory space restriction may be to make part of the executing software invisible from PCI. If it is known in advance what software it to be run on device B, then it is easy to determine how much memory space it will require, and what is the likely effect of the memory space restriction.

The memory space required by device B is reduced to 63 MB, so that the total memory space required by device A and device B is 64 MB. This makes it possible to open a 64 MB window in memory space at the PCI-PCI bridge which is sufficiently large to allow correct functioning of both device A and device B.

It would be preferable to program the BAR of device B to 63 MB rather than 64 MB, such that the BAR's of device A and device B together combine to fill the 64 MB window provided by the window at the PCI-PCI bridge. Unfortunately, the BAR in device B cannot be programmed to 63 MB because the PCI standard specifies that only modulo-2 sizes of memory may be programmed. Thus, the BAR of device B remains programmed to 64 MB, and the first 1 MB of the 64 MB allocated to device B will have the same address as the BAR of device A. An address falling within this first 1 MB would activate both device A and device B, leading to a failure of the system.

In order to avoid the failure of the system, additional hardware is required to decode the address and activate only device A when the address range falls within the first 1 MB of the 64 MB allocated to device B. The hardware used is shown in FIG. 1, and comprises a PCI address decoding device 5 and a zero-delay switch 6 which are added to the PCI bus. The address decoder 5 is connected to PCI_AD[31..1] and PCI_FRAME*. The switch 6 is connected to PCI_FRAME* of the PCI bus. The switch 6 is ‘downstream’ of the PCI_FRAME* link to device A, such that the switch does not disconnect PCI_FRAME* signals passing to device A. Operation of the switch 6 is controlled by the address decoder 5. The switch 6 is chosen to have a low resistance when it is closed and a low capacitance, so that it does not affect the electrical characteristics of the PCI bus.

FIG. 2 illustrates the operation of PCI hardware. A clock signal 10 provides a periodic input to each PCI device connected to the PCI bridge. Each rising edge of the clock signal is interpreted as an incrementation of the clock, and conventionally all operations of the PCI devices are synchronised to these rising edges. A new transaction on-the PCI bus is flagged by the PCI_FRAME* signal 11a going low. Upon determining that the PCI_FRAME* signal has gone low, each PCI device is configured to receive and decode an address. The address is indicated by the PCI_AD[31..0] signal 12. If the address falls within the address range of a given PCI device, then that PCI device will receive that transaction.

Referring to FIG. 1 and FIG. 2, the address decoder 5 is configured to receive and decode the PCI_AD[31..0] signal 12 when the PCI_FRAME* signal 11a goes low. When the decoded PCI_AD[31..0] signal 12 corresponds to an address that falls within the 1 MB range of device A, the address decoder 5 opens the switch 6 (indicated as SWITCH 13 in FIG. 2). Operation of the address decoder 5 and switch 6 is not synchronised to the clock incrementations. Instead, the address decoder 5 continuously monitors the PCI_FRAME* signal, and upon determining that the PCI_FRAME* signal has gone low, immediately decodes the PCI_AD[31..0] signal. Similarly, the switch 6 is opened immediately when the address decoder 5 determines that decoded address falls within the 1 MB range of device A.

Device A and device B sample the PCI_FRAME* signal and PCI_AD[31..0] signal upon each clock incrementation. The clock incrementations are numbered in FIG. 2. At incrementation number 1 PCI_FRAME* is high and device A and device B consequently take no action. At incrementation number 2, PCI_FRAME* has gone low, but the switch 6 has been actuated so that device B is disconnected from the PCI_FRAME* signal. This means that device A determines that PCI_FRAME* is low (as indicated by 11a), and is thus configured to receive and decode an address. Device B determines that PCI_FRAME* is high (as indicated by 11b) and thus takes no action. A pullup resistor 7 is connected to PCI_FRAME* immediately adjacent device B to ensure that PCI_FRAME* remains high when the switch 6 is actuated.

Device A claims the impending transaction by driving DEVSEL 14 low. This indicates that device A is ready to receive data. Once DEVSEL has been asserted, the originator of the transaction knows that device A is listening, and thus transfers data.

It will be noticed that an incrementation of the clock elapses before DEVSEL goes low. This is due to the limited speed of response of device A. A device which responds at this speed is referred to as a ‘Medium’ device. A device which responds after two clock incrementations is referred to as a ‘Slow’ device, and a device which responds before the clock incrementation immediately following the address signal is referred to as a ‘Fast’ device.

At the completion of the transaction, the switch 6 is closed in readiness for the next transaction (not shown in FIG. 2). This allows device B to once more receive (or output) the PCI_FRAME* signal.

It will be appreciated that in order for the illustrated embodiment of the invention to function correctly, the operation of the switch must take place prior the clock incrementation which occurs immediately after PCI_FRAME* has gone low. The time elapsed between the address arriving at the address decoder 5 and the subsequent clock incrementation is indicated in FIG. 2, and is estimated to be around 15 ns for 33 MHz clock incrementations.

Some PCI buses utilise a 66 MHz clock, particularly mezzanine (on-board) busses. Referring to FIG. 2, it is estimated that the elapsed time between an address being provided on the bus and a subsequent clock pulse is around 5 ns for a 66 MHz clock. It would be difficult to implement the address decoder 5 and switch 6 reliably within such a short period of time.

This problem is overcome by the second embodiment of the invention, which is illustrated in FIG. 3. The apparatus shown in FIG. 3 comprises device A and device B, an address decoder 5a and a switch 6a, all connected to a PCI bus generally indicated as 1a. The PCI bus is located behind a PCI-PCI bridge 4a.

The address decoder 5a and switch 6a are more complicated than those illustrated in FIG. 1. Specifically, the address decoder 5a is configured to latch the address (together with control signals) inside the decoder, and drive it to device B with a delay of one clock incrementation. The switch 6a is a 39 bit switch which, in addition to switching the PCI_FRAME* signal, also switches other control signals and the PCI_AD[31..0] signal.

The switch 6a is held open when no transactions are taking place on the PCI bus 1a. When the PCI_FRAME* signal goes low, the address decoder 5a decodes the PCI_AD[31..0] signal. If the decoded address falls within the address range allocated to device B then the PCI_FRAME*, PCI_AD[31..0] signal and control signals are passed to device B. A delay of 1 clock incrementation is incurred, so that the PCI_FRAME* and PCI_AD[31..0] signal arrive at device B one clock incrementation later than would have been the case in the absence of the address decoder 5a and switch 6a. Simultaneous with passing the FRAME* and PCI_AD[31..0] signals to device B, the switch 6a is closed. Device B decodes PCI_AD[31..0] and then pulls DEVSEL low, indicating that it is ready to receive data DEVSEL* assertion informs the initiator that the transaction has been claimed by device B, and allows data transfer to take place via PCI_AD[31..0].

The switch 6a is opened once communication with device B has been completed.

Device B may wish to initiate communication via the PCI bus. To do this, device B conventionally emits a REQUEST signal. A separate arbitration device (not shown) determines when device B may use the bus, and returns a GRANT signal which permits device B to take ownership of the bus and initiate a transaction. The address decoder 5a includes an input from the GRANT signal input of device B. When this signal is asserted, the switch 6a is closed to allow device B to communicate.

If the address decoder determines that the address lies within the address range of device A, then the switch 6a remains open. The address and the control signals are not passed to device B. Device A communicates with the PCI bus in the conventional way.

As noted above, the response of device B to a PCI_FRAME* and PCI_AD[31..0] signal is one clock incrementation slower than would be the case in a conventional PCI system, the delay being introduced by the address decoder 5a. This means that when the second embodiment of the invention is used, a device which would normally respond to a PCI_FRAME* and PCI_AD[31..0] signal by the third clock incrementation (i.e. a ‘slow’ device) will not respond until the fourth clock incrementation. Unfortunately, under the PCI standard, an initiator of a transaction will wait for only 3 clock incrementations for a reply after outputting a PCI_FRAME* and PCI_AD[31..0] signal. If not reply has been received after three clock incrementations, the initiator of the transaction will interpret the absence of a response as an error. Thus, where the second embodiment of the invention is used, device B cannot be a slow device. In the same way, if device B is inherently a “fast” device, it will become “medium” as a result of adding the address decoder 5a, whilst if it is inherently “medium”, it will become “slow”.

The second embodiment of the invention introduces a time cost of one cycle only during the address phase at the start of a transaction—there is no additional delay during the data phase, or phases which follow. Communication with device A occurs in the conventional way, and does not incur any time cost.

FIG. 4 illustrates an application of the second embodiment of the invention. A 66 MHz mezzanine (on-board) PCI bus, generally indicated as 21, interconnects two Motorola MPC107 PowerPC bridges 22, 23, a PCI Mezzanine Card expansion site 24, and a PCI-PCI bridge 25 connecting to a host backplane PCI bus system. An “Address Map Control” (AMC) Programmable Logic Device (PLD) 26 corresponds to the address decoder 5, 5a shown in FIGS. 1 and 3. The AMC is responsible for decoding addresses on the local PCI bus 21 and selectively disconnecting the PCI_AD[31..0] signal and control signals from the second Motorola MPC107 PowerPC bridge 23 using a 39 bit switch 27. This allows a single block of 64 MB address space to be divided between the MPC107 and the device installed in the PMC site. In this example a register in the AMC can be written to by the system host to define the required split between allocated address spaces, so that different devices can be installed in the PMC site and correctly handled.

1. A peripheral component interconnect (PCI) bus memory addressing system comprising a memory address decoder and disconnection means connected to a PCI bus, the disconnection means being arranged to disconnect one or more signals of the PCI bus from a first PCI device, wherein the memory address decoder is arranged to selectively activate the disconnection means such that an address which falls within an address range identified in a base address register of the first PCI device and a base address register of a second PCI device will be received by the second PCI device but not by the first PCI device.

2. A PCI bus memory addressing system according to claim 1, wherein the disconnection means comprises a switch arranged to disconnect the PCI_FRAME* signal from the first PCI device.

3. A PCI bus memory addressing system according to claim 2, wherein the switch is closed when no data transactions are taking place, the switch being opened when the memory address decoder decodes an address which falls within the address range identified both in the base address register of the first PCI device and the base address register of the second PCI device.

4. A PCI bus memory addressing system according to claim 3, wherein the switch remains open during a transaction with the second PCI device, and is closed when that transaction ends.

5. A PCI bus memory addressing system according to any of claims 2 to 4, wherein the switch is a zero delay switch, and the memory address decoder is arranged to decode an address and open the switch prior to a clock incrementation which immediately follows the address signal.

6. A PCI bus memory addressing system according to claim 1, wherein the disconnection means comprises a switch arranged to disconnect the PCI_FRAME* signal, the PCI_AD[31..0] signal and other control signals from the first PCI device.

7. A PCI bus memory addressing system according to claim 6, wherein the switch is open when no data transactions are taking place, the switch being closed when the memory address decoder decodes an address which falls within the address range identified in the base address register of the first PCI device and which does not fall within the base address register of the second PCI device.

8. A PCI bus memory addressing system according to claim 7, wherein in addition to opening the switch, the memory address decoder transfers the address, PCI_FRAME* and other control signals to the first PCI device.

9. A PCI bus memory addressing system according to claim 8, wherein the address, PCI_FRAME* and other control signals are transferred to the first PCI device after a clock incrementation which immediately follows the address signal.

10. A PCI bus memory addressing system according to any of claims 7 to 9, wherein the switch remains closed until the transaction with the first PCI device is complete, whereupon the switch is opened.

11. A PCI bus memory addressing system according to any of claims 6 to 10, wherein the switch is a 39 bit switch.

12. A PCI bus memory addressing system according to any of claims 6 to 11, wherein the switch is a zero-delay switch.

13. A PCI bus memory addressing system according to any of claims 6 to 12, wherein the other control signals include at least one of PCI_IRDY*, PIC_PAR and PCI_CBE[3..0]*.

14. A PCI bus memory addressing system according to any preceding claim, wherein the first and second PCI devices, the memory address decoding means, the switch and the PCI bus are all located behind a PCI-PCI bridge.

15. A PCI bus memory addressing system according to any preceding claim, wherein the memory address decoder is programmable, and is programmed with allocated address ranges for the first and second PCI devices.

16. A PCI bus memory addressing method comprising determining the memory space requirements of a first PCI device and a second PCI device connected to a PCI bus, restricting the memory space used by the first PCI device, and allocating the address range of the resulting spare memory space to the second PCI device, wherein the method further comprises connecting a memory address decoder and a disconnection means to the PCI bus, the memory address decoder being arranged to selectively activate the disconnection means such that an address which falls within an address range identified in a base address register of the first PCI device and a base address register of a second PCI device will be received by the second PCI device but not by the first PCI device.

17. A PCI bus memory addressing system substantially as hereinbefore described with reference to the accompanying figures.

18. A PCI bus memory addressing method substantially as hereinbefore described with reference to the accompanying figures.
